(19) United States
(12) Patent Application Publication
(10) Pub. No.: US 2012/0282027 A1
(43) Pub. Date: Nov. 8, 2012

(54) Actuating Device For A Soil Compaction Device With An Internal Combustion Engine And A Soil Compaction Device With Such An Actuating Device

(75) Inventors: Heinz Nick, Emmelshausen (DE); Dirk Bonnemann, Oberelbert (DE); Werner Nick, Maisborn (DE)

(73) Assignee: BOMAG GMBH, Boppard (DE)

(21) Appl. No.: 13/460,897

(22) Filed: May 1, 2012

(30) Foreign Application Priority Data
May 2, 2011 (DE) 10 2011 100 155.0

(51) Int. Cl. F02D 9/00; E01C 19/35

(52) U.S. Cl. 404/133.1; 123/332

(57) ABSTRACT

The present invention relates to an actuating device for a soil compaction device with an internal combustion engine, such as a vibration tamper, for joint actuation of an engine stop switch and a tank shut-off valve. It is provided that the actuating device comprises one single movable actuating means or element for the direct joint actuating of the engine stop switch and the tank shut-off valve. The invention further relates to a soil compaction device with such an actuating device.

### CROSS-REFERENCE TO RELATED APPLICATIONS

The present application claims priority under 35 U.S.C. §119 of German Patent Application No. DE 10 2011 100 155.0, filed May 2, 2011, the disclosure of which is hereby incorporated herein by reference in its entirety.

### FIELD OF THE INVENTION

The present invention relates to an actuating device for a soil compaction device with an internal combustion engine, especially for a vibration tamper, which is used for joint actuation of an engine stop switch and a tank shut-off valve, and a soil compaction device with such an actuating device.

### BACKGROUND OF THE INVENTION

In the case of a soil compaction device with an internal combustion engine, fuel from the fuel tank can reach the internal combustion engine during transport or prolonged storage, which is undesirable. This is especially the case for internal combustion engines with a diaphragm carburetor device, since fuel is aspirated by the diaphragm carburetor device during shaking and is conveyed into the internal combustion engine, which can lead to considerable starting difficulties for example. It is therefore known to provide a tank shut-off valve with which the flow of fuel from the fuel tank to the internal combustion engine or its carburetor device can be interrupted. Furthermore, the integration of an engine stop switch in a soil compaction device is known. The engine stop switch is arranged in a manner that it interrupts the power supply of the ignition circuit in one position (“engine-off position”), by means of which operation of the internal combustion engine is excluded, and closes the ignition circuit in another position (“closed position”), which enables the operation of the internal combustion engine. If the interruption of the ignition circuit occurs during running operation of the internal combustion engine, an actuation of the engine stop switch will accordingly lead to an immediate engine stop. On the other hand, starting of the internal combustion engine is not possible as long as the engine stop switch is in its “interrupted position”.

An actuating device is known from DE 195 49 113 C1, with which both an engine stop switch and a tank shut-off valve can be actuated successively. This actuating device comprises an actuating member in form of a pivoting lever which can selectively be pivoted between different operating positions and a stop position which will stop the internal combustion engine. When the pivoting lever is pivoted to the stop position, the tank shut-off valve will be closed directly by way of a cam arranged on the pivoting lever. Furthermore, the engine stop switch will be actuated upstream via a Bowden cable, which leads to an immediate stop of the internal combustion engine in that the ignition is short-circuited for example. By pivoting the pivoting lever from the stop position, the tank shut-off valve will be opened again and the actuation of the engine stop switch will be removed, so that the internal combustion engine can be started. The prior known actuating device is susceptible to malfunction and frequently leads to the consequence that the engine is inadvertently switched off when the operating lever is moved beyond its idle position to the engine stop position.

### SUMMARY OF THE INVENTION

It is therefore an object of the present invention to provide a simple and sturdy actuating device for a soil compaction device, which on the one hand ensures a reliable cut-off of the internal combustion engine and simultaneously offers increased operating convenience.

According to one aspect of the present invention, two actuating means or elements are provided for operating the soil compaction device, which actuating means or elements are respectively associated with different operating functions. The first actuating element is provided in a known manner for regulating the engine power between an idle state and a full throttle state. In other words, the first actuating element is a throttle lever via which the engine power can be adjusted between idling and full throttle. The operator can control the working intensity of the soil compaction device with a running internal combustion engine via a respective adjustment of the first actuating element.

In accordance with one embodiment of the present invention, the entire actuating device also comprises a separate second actuating means or element in addition to the first actuating element, via which a manual control of the operating functions is provided, which specifically relates to the control of a tank shut-off valve and an engine stop switch. The fuel supply from the tank to the internal combustion engine can be interrupted and released by a control of the tank shut-off valve. The control of the engine stop switch on the other hand allows producing or interrupting the power supply to the internal combustion engine, e.g., for supplying the ignition circuit. The second actuating element is therefore used for the purpose of switching the soil compaction device back and forth between a state that is “ready for operation” and a state of “no operation”, whereas the first actuating element is used for regulating the operating state of “ready for operation” and “in operation”. The first and the second actuating element of the actuating device can be controlled separately from one another, with a regulation of the throttle via the first actuating element obviously only making sense when the internal combustion engine is running.

It is possible that further control functions are co-controlled via the actuating device and especially also via the second actuating element. However, it has proven to be advantageous in one embodiment to use the second actuating element exclusively for actuating the tank shut-off valve and the engine stop switch. It is ensured in this manner that there is a clear separation for the operation between the states of “ready for operation”/“in operation” and “no operation”/“engine off”.

In one embodiment, the second actuating means or element is arranged in a manner that it actuates the tank shut-off valve and the engine stop switch at least substantially simultaneously, especially when adjusting its position from “ready for operation” in the direction towards “no operation”, with a respective configuration for the reversed switching path also being possible in a supplementary or alternative manner. The terminology of “substantially simultaneously” shall be understood in such a way to mean that the changeover of the tank shut-off valve and the engine stop switch occurs in a virtually simultaneous manner in case of a manual actuation of the second actuating element by an operator. According to one aspect of the present invention, the change over of the tank shut-off valve and the engine stop switch may occur simultaneously in a manner as precisely as possible. The operator therefore merely needs to overcome a switching point with the second actuating means in order to trigger the two functions of “interruption”/“release” depending on the direction of actuation by the tank shut-off valve and “actuation”/“release” of the engine stop switch. It will be understood that marginal tolerances can occur that are caused by production. The relevant aspect for the simultaneous occurrence of the actuation is that both the engine stop switch and the tank shut-off valve are actuated virtually simultaneously, especially with respect to the entire actuating path of the second actuating means, and/or, depending on the embodiment, are released.

Principally, the particular configuration of the second actuating means can vary over a wide spectrum. In one embodiment, it is arranged for the direct actuation of the engine stop switch and/or the tank shut-off valve in order to avoid complex transmission devices. A direct actuation is provided when the second actuating means directly triggers the engine stop switch and/or the tank shut-off valve. Principally, an arrangement of the second actuating means close to the engine stop switch and/or the tank shut-off valve, especially as a compact and connected unit, has proven to be advantageous.

Considering the numerous configuration alternatives that may be considered such as rocking levers, thrust levers, etc., the arrangement of the second actuating means in form of a rotary lever, which will also be designated below as a rotary switch, has proven to be advantageous. A rotary switch is characterized in that it is twisted or rotated for switching or actuation and therefore requires very little space. A rotary switch is further especially suitable for transmitting actuating forces from the second actuating means in a suitable manner to the tank shut-off valve and the engine stop switch.

In order to enable a manual control of the rotary switch, it may comprise a grip end in form of a protruding beam for example. For the purpose of transmitting the switching motion, this embodiment further preferably comprises a shaft which is connected with the grip end in a torsion-proof manner, wherein both the tank shut-off valve and also the engine stop switch can be actuated indirectly or especially directly via the shaft. A shaft shall generally be understood in the present case as being an element of random cross-section which is rotatable about a rotational axis and is capable of transmitting rotational movements and rotational forces (torques), especially in the manner as will be described below in closer detail. As a result of the torque-proof connection of the grip end with the shaft, the shaft will co-rotate during a rotational actuation of the grip end. This movement will be utilized in the present case to actuate the engine stop switch and the tank shut-off valve together and in a substantially simultaneous manner. When the rotary grip end is pivoted to the engine stop position while the internal combustion engine is running, the tank shut-off valve on the one hand will therefore be closed virtually in the same moment or on exceeding a common switching point, whereupon the fuel connection from the fuel tank to the internal combustion engine will be interrupted, and on the other hand the internal combustion will be switched off by the engine stop switch, which can occur by interrupting the ignition circuit for example. When the rotary grip end is twisted or rotated back from the engine stop position to an operating position, the tank shut-off valve will be opened and the interruption of the ignition circuit will be removed, whereupon the internal combustion engine is started and can be operated. The second actuating means can be arranged in a manner that actuation of the engine stop switch and the tank shut-off valve in the one direction of actuation (i.e., from the engine off position in which the engine stop switch interrupts the ignition circuit and the tank shut-off valve interrupts the fuel supply, to the operating position, in which the engine stop switch closes the ignition circuit and the tank shut-off valve releases the fuel supply from the fuel tank to the internal combustion engine or carburetor), or in the other direction of actuation (from the operating position to the engine off position), and preferably in both switching directions, switches over the engine stop switch and the tank shut-off valve virtually simultaneously or upon exceeding a respectively common switching point. This enables the simultaneous triggering of the respective control processes by the tank shut-off valve and the engine stop switch, which therefore ensures, for example, depending on the respective embodiment, that the fuel supply is interrupted simultaneously with the cut-off of the internal combustion engine and/or vice versa. This leads to the advantage for the operator that both control functions are performed with one adjustment. Furthermore, intermediate positions between a changeover of the engine stop switch and an actuation of the tank shut-off valve will no longer occur.

The shaft of the rotary switch can be used on the one hand for bearing the rotary switch. In one embodiment, the shaft comprises a co-rotating contact device which is arranged for actuating the engine stop switch and/or the tank shut-off valve. Correspondingly, the shaft preferably comprises a co-moved contact device for contacting or even contactless actuation, especially for the engine stop switch. The engine stop switch can be arranged as a touch contact, for example, for contacting actuation. It can be provided for this purpose that the engine stop switch will interrupt the ignition circuit in the pressed state and close the engine stop switch in the non-pressed state. For contactless actuation, the engine stop switch can be arranged as a magnetic switch or reed contact switch.

An arrangement of the contact device in the form of a control surface has proven to be especially advantageous in practical use. It is especially suitable for controlling the engine stop switch which is frequently arranged as a touch contact. The control surface designates a surface along which a member to be controlled, such as the sensing head of a touch contact, is moved during an actuation movement of the second actuating means. Specifically, arrangements of the contact surface as a radially curved area, or as an area which is eccentric with respect to the rotational axis, or as cams in the rotational plane of the rotary switch, have proven to be especially suitable. In this embodiment, the touch contact, which is usually pressurized by a pressure spring, rests on the control surface and is pressed in beyond its switching point as a result of the special arrangement of the control surface when actuating the rotary switch or, depending on the direction of rotation, is pressed out, or a return is enabled by the restoring force provided internally in the switch. A switching point shall designate a point in the switching motion of the touch contact, at which, when exceeded, it will move from its one switching position (e.g., its position interrupting the ignition circuit) to its other position (e.g., its position closing the ignition circuit). The control surface can be arranged as a radially curved area. A radially curved area is characterized in that it comprises changing distances to the rotational axis in a plane orthogonally to the rotational axis of the rotary switch in the radial direction, wherein especially flowing changes in the distance are advantageous in order to enable the smoothest possible switching process.

In one embodiment, the control surface and the element actuated by the control surface, especially the engine stop switch arranged as a touch contact, are arranged in the manner with respect to one another that the control surface adjusts the engine stop switch orthogonally to the rotational axis of the shaft. This ensures an especially efficient transmission of the rotating actuating movement of the second actuating means to the engine stop switch.

The control surface is therefore preferably arranged as a contact area which co-rotates with the shaft, thereby enabling a contacting actuation of the engine stop switch during a rotational movement of the rotary lever. Alternatively, a contactless actuation can also be provided, e.g., by means of a reed contact. In both cases, the contact device will co-rotate with the shaft.

As an alternative or in addition to a contact area acting in the radial direction of the rotary shaft, it is also possible, for example, that the rotatable shaft is axially displaced simultaneously with the rotation about the rotational axis, which can be achieved by a rotational adjusting mechanism (such as a power-transmission thread or the like). In this case the actuation of the engine stop switch or the tank shut-off valve can occur in the axial direction of the shaft. Both embodiments (actuation in the radial direction and actuation in the axial direction) can also be combined with one another.

The triggering of the tank shut-off valve is also principally variable. A mechanical actuation—especially with the help of an actuating device which co-moves with the rotary lever—is advantageous in order to achieve reliable operation of the actuating device. One implementation of the present invention provides that a connecting device is provided at the bottom axial end of the shaft (i.e., at the end of the shaft opposite of the rotary lever) which is arranged in a manner that it transmits a rotational movement of the rotary lever to a rotary valve of the tank shut-off valve. A rotary valve is characterized in this case in that it can be moved by a rotational movement between an opened and a closed position. For this purpose, the shaft can be linked to a ball valve which is incorporated in the fuel line, with the linkage being made in a direct manner or also by a suitable connecting device. It may be advantageous for reasons of space if the rotational axes of the rotary lever and the rotary valve are disposed coaxially with respect to each other. This is achieved in a very positive way when the rotary valve is adjacent to a face end of the shaft. It is alternatively possible that the tank shut-off valve is actuated by means of a slide or the like which is actuated by the rotational shaft, so that tank shut-off valves without rotary valves can be used as well. Of course electrically actuatable valves or further alternative valves can also be used.

The linkage of the shaft to the respective actuating component of the tank shut-off valve preferably occurs by means of a positive and/or non-positive connection. As a result, the shaft can contain a receiving recess directed in the radial direction for example in which a rotatable part of the tank shut-off valve, e.g., a projection in the valve ball of a ball valve, will engage.

The second actuating means, especially in form of the rotary switch, is further preferably mounted in a relatively movable manner in a housing. An extremely compact modular unit can thereby be obtained. This applies especially for an arrangement of the second actuating means as a rotary lever with a grip end and a shaft which is torsion-proof with respect to the grip end. The housing further ideally comprises guide means especially for this embodiment in the manner that the rotary lever is securely mounted in the housing on the one hand and enables a rotational movement for actuating the engine stop switch and the tank shut-off valve on the other hand. It is appropriate that also the engine stop switch and/or the tank shut-off valve are housed in the housing and/or are fastened or mounted in the housing in order to ideally obtain a compact and connected mounting unit.

In order to facilitate the operation of the actuating device by the operator, the limitation of the rotational movement of the rotary lever of the second actuating means by a limitation device, especially a limit stop, has proven to be advantageous in a rotational bearing of the rotary lever, especially the housing. The limitation device is effective in at least one actuation direction of the rotary lever and thereby predetermines a maximum actuation path for the movable actuating means. A maximum actuating path can therefore not be exceeded. It is thus ensured that the operator is unable to overtwist the rotary lever and thereby damage parts of the linkage to the engine stop switch and/or the tank shut-off valve. It is therefore optimal, in one embodiment, when the actuating movement is delimited in both actuating directions, i.e., when using a rotary lever in both rotational directions, respectively by a limitation device, especially a limit stop. For this purpose, the limitation device can be formed by one or even two mechanical motion stops. Such a mechanical motion stop is arranged in an especially preferred manner as a soft limit stop, which can be effected by an elastic tongue arranged on the housing, against which the movable actuating means will impinge in a soft fashion upon reaching its final movement position, for which purpose a contact element is provided on the movable actuating means which corresponds with the tongue. The tongue and the contact element can also be arranged in an exchanged manner.

As an alternative or in addition to a limit stop, a latching or locking device can be provided for latching or locking the rotary lever in at least one defined position. The difference between the latching or locking device and the limit stop is that it does not necessarily represent an actuating path limitation. The rotary lever can respectively also be moved beyond the latching or locking position. The latching or locking device ensures that the second actuating means will assume a specific defined actuating position which can be perceived by the operator. It is thereby ensured that the operator will reach the joint switching point of the engine stop switch and the tank shut-off valve, depending on the position of the latching or locking device for opening the tank shut-off valve and for releasing the ignition contact by the engine stop switch or for closing the tank shut-off valve and for interrupting the ignition contact by actuating the engine stop switch. The latching device is characterized in that it is arranged in a manner for ensuring a switching process that it will conceivably latch before and/or after the switching point (i.e., after reaching the switching point). The relevant aspect of the locking device is that it comprises means which enable fixing the second actuating device in a position before and/or after the switching point. Both embodiments come with the advantage that the switching position of the second actuating means is additionally secured, which is especially advantageous during transport when the actuation of the engine stop switch (for interrupting the ignition contact) and the positioning of the tank shut-off valve in a position interrupting the fuel supply are to be ensured. Securing the second actuating means can also additionally or alternatively be provided for the operating state in order to fix the tank shut-off valve in an opened position and the engine stop switch in a position that does not interrupt the ignition circuit. This is especially advantageous with respect to the considerable vibrations occurring in the operation of the soil compaction apparatus. The locking or latching device preferably acts between the housing and a part of the rotary lever, especially by corresponding locking or latching elements.

Although a broad spectrum of various embodiments can be used for implementing the present invention, an integral arrangement of the rotary lever, i.e., the shaft and the grip end, have proven to be ideal especially in one embodiment in order to simplify production and maintenance. Further, especially in the case of an integral arrangement of the rotary lever, plastic material is preferably used, especially a cold-resistant and impact-proof plastic material, especially from the group of the thermoplastic materials. The latter especially allows production by way of an injection-molding process, by means of which the production process can be further optimized. Reinforcing materials can principally also be incorporated in the plastic material.

The engine stop switch is frequently a contact or pressure switch. Although such switches are relatively robust, excessive pressing in should principally also be avoided in these switches in order to permanently ensure reliable functioning. Excessive pressing can for example damage the restoring mechanism of the engine stop switch which is frequently arranged in form of a restoring spring. The present invention provides, in one embodiment, the presence of an elastic loading protection for this purpose, which is arranged in the manner that a maximum actuating path of the engine stop switch is not exceeded in at least one actuating direction. The loading protection can especially be arranged in the manner that the engine stop switch will yield upon exceeding a maximum actuation of the actuating force, e.g., transmitted by a control surface which is in contact with the engine stop switch. The bearing of the engine stop switch can specifically be provided in a protruding bearing tongue, with the bearing tongue preferably being connected only on one side with a bearing body, especially a part of the housing. The bearing tongue is provided with a certain amount of elasticity, especially when it is made of plastic. An integral arrangement of the bearing tongue with a relevant part of the housing is ideal, e.g., one half of the housing. If the actuating force acting on the contact switch therefore exceeds a maximum value, the contact switch yields by bending of the bearing tongue, as a result of which overload protection for the contact switch is achieved.

A soil compaction device incorporating at least one actuating device in accordance with the present invention may comprise a hand-operated soil compaction device, especially a vibration tamper or a vibrating plate. The actuating device is preferably fixed to a fuel tank of the soil compaction device or integrated in a housing of the fuel tank.

### BRIEF DESCRIPTION OF THE DRAWINGS

The present invention will be described below in a non-limiting way by reference to the embodiment shown in the drawings, which schematically show as follows:

FIG. 1 shows a perspective view of a soil compaction device;

FIG. 2 shows a longitudinal sectional view of the second actuating means or element which is installed in the soil compaction device of FIG. 1;

FIG. 3 shows a cross-sectional view of the second actuating means or element installed in the soil compaction device of FIG. 1, according to the sectional progression as shown in FIG. 2, with non-actuated engine stop switch and opened tank shut-off valve;

FIG. 4 shows the second actuating means or element installed in the soil compaction device of FIG. 1 in a cross-sectional view corresponding to FIG. 3, with actuated engine stop switch and closed tank shut-off valve;

FIGS. 5a and 5b show a schematic comparison of the switching processes under actuation of the rotary switch in the direction of “engine stop” and in the direction of “ready for operation”, and

FIG. 6 shows a perspective sectional view of FIG. 1.

### DETAILED DESCRIPTION

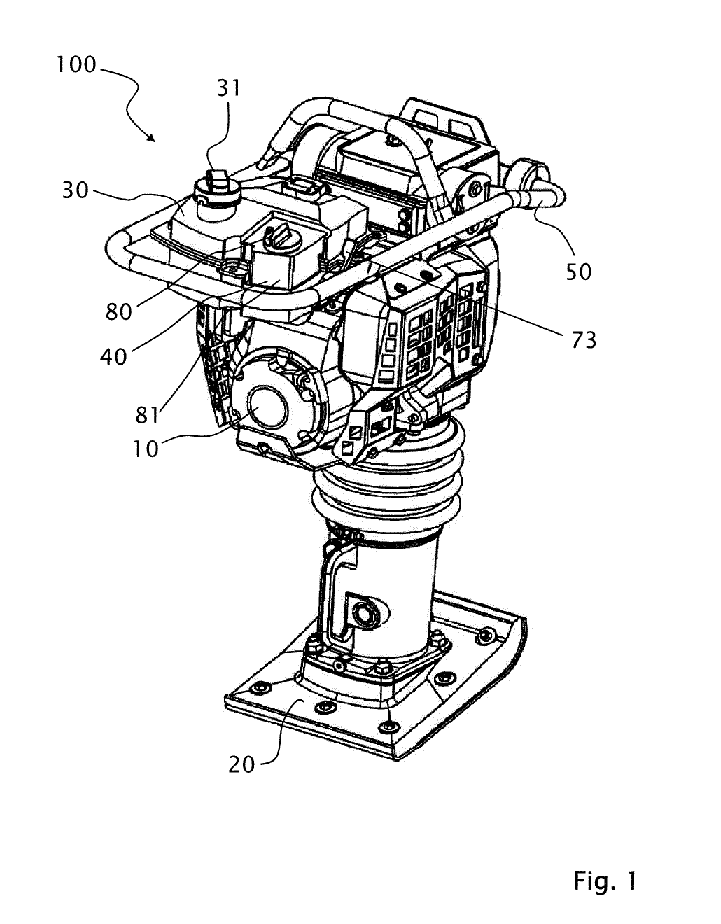

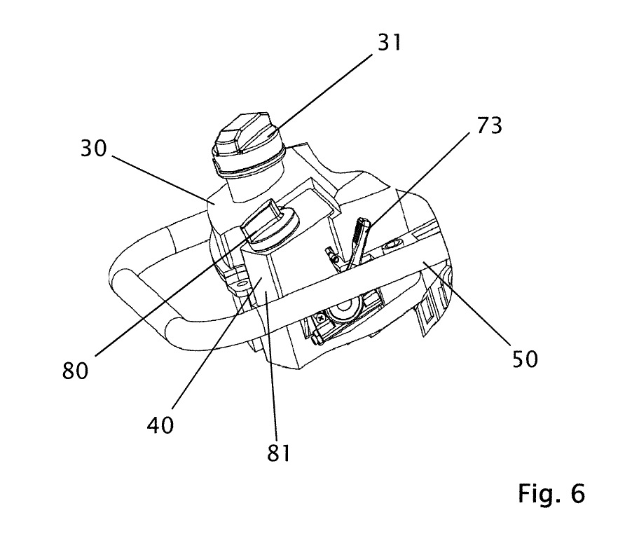

FIG. 1 shows a soil compaction device which is designated in its entirety with reference numeral 100, with the device comprising a so-called vibration tamper in the exemplary embodiment. The soil compaction device 100 comprises an internal combustion engine 10 which is connected with a soil compaction plate 20 via a mechanical drive. Reference numeral 30 designates the fuel tank in which fuel is stored for operating the internal combustion engine 10. Reference numeral 40 designates an actuating device according to one embodiment which comprises a first actuating means or element 73 in form of an accelerator lever and a second actuating means or element 80 which will be described below in greater detail for the joint and simultaneous actuation of an engine stop switch and a tank shut-off valve. The engine power can be regulated by actuating the accelerator lever 73 to vary the number of strokes of the soil compaction plate 20 per unit of time. As is illustrated, the second actuating means 80 of the actuating device 40 is fixed to the fuel tank 30 or a housing of the fuel tank 30. Reference numerals 31 and 50 designate a tank lid 31 and a handle 50. FIG. 6 shows the actuating device 73 in greater detail, especially the relative position and the spatial separation of the first actuating means 73 and the second actuating means 80.

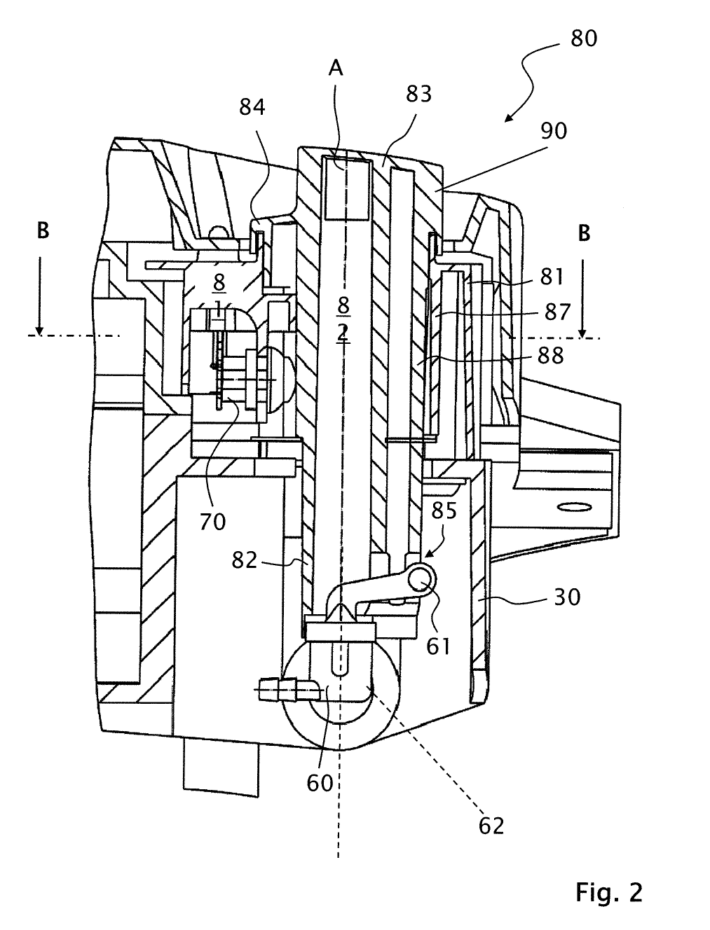

FIG. 2 shows the second actuating means or element 80 in a longitudinal sectional view. The second actuating means or element 80 comprises a housing 81 in which a rotatable actuating means is held which is arranged as a rigid shaft 82. At its upper axial end, the shaft 82 is arranged integrally with an actuating member arranged as a twist or rotatable handle 83. The twist handle 83 comprises a handle rib as shown in FIG. 1. The twist handle 83 and the shaft 82 jointly form a rotary lever 90. A sliding block guide 84 is provided on the housing 81 (sealing against rainwater) for guiding and sealing the twist handle 83. The shaft 82 protrudes downwardly out of the housing 81 and comprises at its axially bottom end a connecting section 85 which extends over the actuating arm 61 of a tank shut-off valve 60 in an interlocking fashion, thus producing an interlocking connection between the shaft 82 and the actuating arm 61 of the tank shut-off valve 60. The mechanical tank shut-off valve 60 is provided for interrupting the fuel connection between the fuel tank 30 and the internal combustion engine 10 on the soil compaction device 100. In the illustrated embodiment, the tank shut-off valve 60 is fastened directly to the tank 30 or its housing. The tank shut-off valve 60 concerns a conventional tank shut-off valve in form of a ball valve or ball check valve with a valve ball 62 (not shown) which is actuated by means of the actuating arm 61. The valve ball 62 of the tank shut-off valve 60 can be actuated by manual application of a rotational force on the twist handle 83 via the shaft 82 and the actuating arm 61. The common coaxial rotational axis of the ball valve 62, the actuating arm 61, the shaft 82 and the twist handle 83 is designated with reference A.

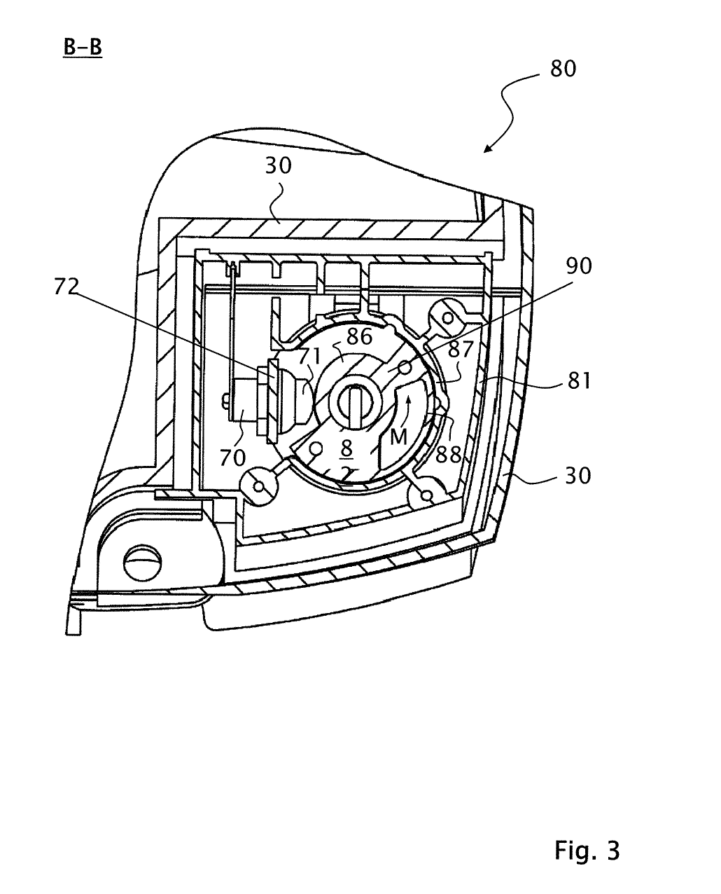

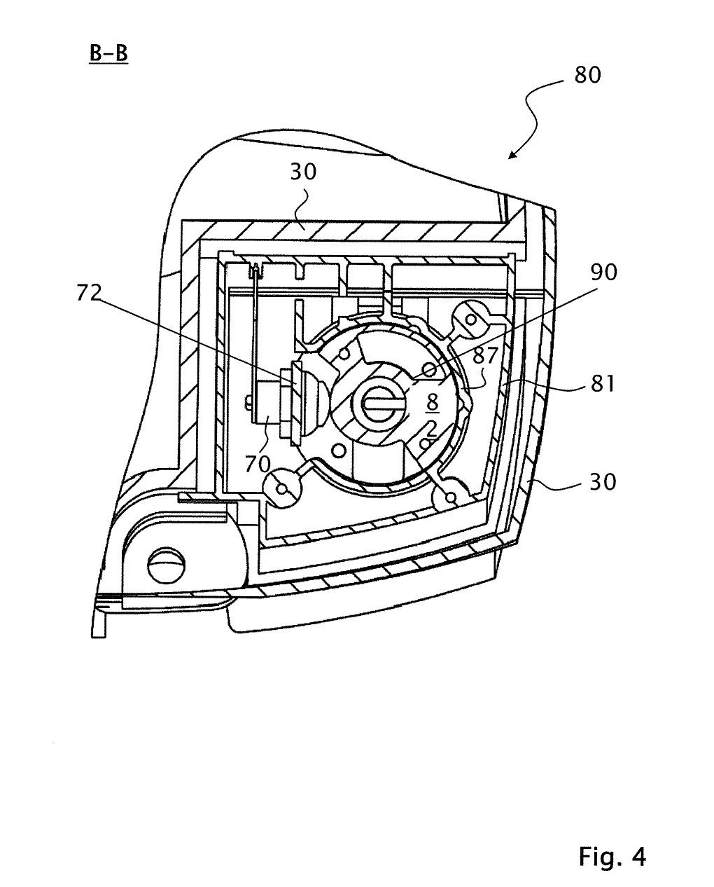

Reference numeral 70 relates to an engine stop switch which is arranged in the housing 81 of the second actuating means or element 80 and which is similarly actuated in a virtually simultaneous manner with an actuation of the tank shut-off valve when the shaft 82 is twisted, as will be described below in greater detail in connection with FIGS. 3 and 4. For this purpose, the engine stop switch is pressed by the shaft 82 from the position as shown in FIG. 3 in the radial direction with respect to the rotational axis A to the position shown in FIG. 4.

FIG. 3 shows a sectional view through the second actuating means 80 according to the progression of the section B-B as shown in FIG. 2, with the sectional view offering a top view of the engine stop switch 70. The engine stop switch 70, which is elastically mounted via a tongue 72, is arranged as a contact switch and comprises a resiliently pretensioned actuating element 71 which is actuated by way of contact by the shaft 82. Shaft 82 is arranged in the region of contact of the engine stop switch 70 as a control surface 86 which is curved in the radial direction with respect to the rotational axis A and forms a contact device which co-rotates with the shaft 82 and which is arranged for pressing in and therefore actuating the contact switch 70. The control surface 86 is arranged integrally with the shaft 82. The arrangement of the engine stop switch 70 on the bearing tongue 72 ensures that the engine stop switch 70 is able to yield in its entirety upon exceeding a maximum load exerted by the control surface in the actuating direction of the engine stop switch 70, so that a loading protection is obtained in total with the arrangement of the engine stop switch 70 in the bearing tongue 72. The bearing tongue is connected for this purpose with the housing 81 of the second actuating means or element 80 which is fixed with respect to the soil compaction device and is mounted on the same.

In the illustration as shown in FIG. 3, the shaft 82 is disposed in an operating position in which the engine stop switch 70 is not actuated and the tank shut-off valve 60 is opened. The internal combustion engine 10 can therefore be started and operated. By manually applying a rotational force on the twist handle 83, the shaft 82 is moved or twisted towards the position as illustrated in FIG. 4, which is illustrated by the rotating arrow M. As a result, the shaft 82 actuates both the tank shut-off valve 60 and also the engine stop 70 in a direct and substantially simultaneous manner. The actuation of the tank shut-off valve 60 occurs by way of the connecting section 85 on the bottom axial end of shaft 82 as described above, with the fuel connection between the fuel tank 30 and the internal combustion engine 10 from FIG. 3 to FIG. 4 being interrupted. The actuation of the engine stop switch 70 occurs by way of the control surface 86 which presses the actuating element 71 in the radial direction away from the rotational axis A and pushes the same into the engine stop switch 70, whereupon it is actuated and interrupts the ignition circuit of the internal combustion engine 10. In the position as shown in FIG. 4, the second actuating element 80 is therefore in the operating state of “engine off” and the starting and operation of the soil compaction device 100 is not possible. If the second actuating element 80 is twisted or rotated from the position as illustrated in FIG. 4 to the position as illustrated in FIG. 3, the second actuating element 80 will be disposed in the operating position of “ready for operation” and operation of the internal combustion engine 10 is possible. As long as the shaft 82 is in the rotational position as shown in FIG. 3, the internal combustion engine 10 can therefore be started and operated, with the regulation of the speed occurring separate from the second actuating means 80 alone by way of the first actuating means of the actuating device 40. In order to interrupt the operation of the internal combustion engine 10, the shaft 82 needs to be twisted or rotated in the opposite rotating direction (M), which occurs by renewed manual application of a rotational force on the twist handle 83. In this process, the tank shut-off valve 60 will be closed again and the actuated engine stop switch 70 simultaneously interrupts the ignition circuit of the internal combustion engine 10. Merely for reasons of precaution it is noted that the aforementioned switching function of the engine stop switch 70 and its actuation are only of an exemplary nature.

The control angle for the shaft 82 which lies between the rotational position as shown in FIG. 3 and the rotational position as shown in FIG. 4 is 90° (quarter circle). This corresponds to a preferred maximum control angle, because the rotational movement can still be applied conveniently on the twist handle 83 for this purpose without requiring the operator to move the hand excessively. The maximum control angle can be predetermined by a limiting device which is not described in closer detail. Furthermore, locking and/or latching means can be provided which are not described in closer detail and which detachably fix the shaft 82 and/or the twist handle 83 in an operating position or the engine stop position.

FIGS. 2, 3 and 4 show clearly that a guide device 87 is arranged on or in the housing 81 with an at least partly cylindrical inside guide surface which is used for the rotational bearing and support of the shaft 82 (also see FIG. 1) on or in the housing 81. Shaft 82 is arranged for this purpose with a corresponding skirt-like guide section 88. The illustration further shows clearly that the shaft 82 is not massive but is arranged as a hollow shaft.

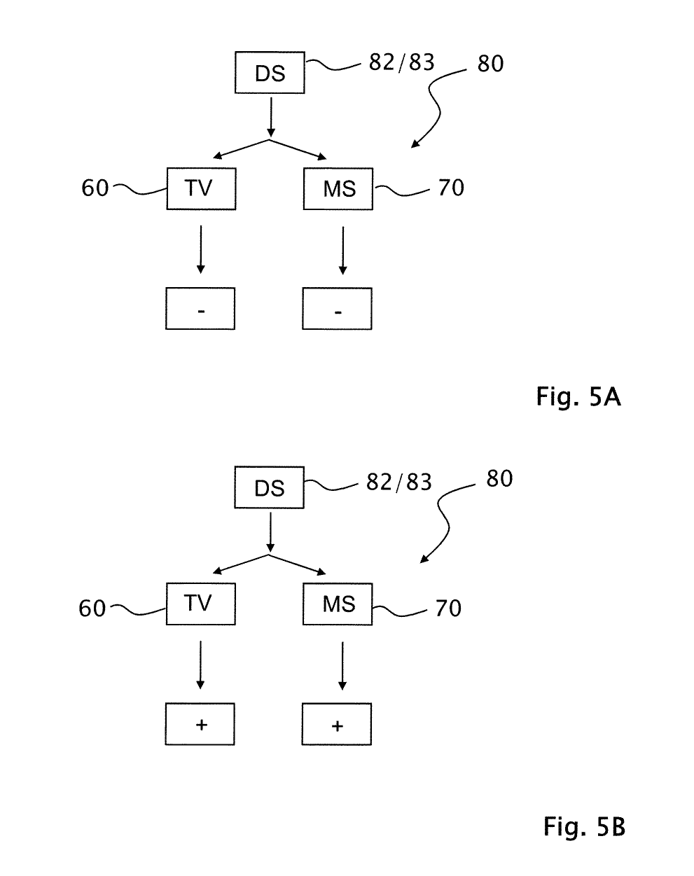

A rotatable shaft 82 is provided in the illustrated embodiment as an actuating means for the joint actuation of the tank shut-off valve 60 and the engine stop switch 70. A longitudinally displaceable slide and/or an electric switch could be provided in an analogous manner as an actuating means, with which both the tank shut-off valve 60 and the engine stop switch 70 can be actuated. A relevant aspect is that the tank shut-off valve 60 and the engine stop switch 70 are actuated simultaneously in one embodiment. This is further shown in FIGS. 5a and 5b. FIG. 5a shows the switching state of FIG. 4. The engine stop switch 70 interrupts the ignition circuit of the internal combustion engine 10 (symbolized by a “-”) and the tank shut-off valve 60 interrupts the further transport of fuel from the tank 30 to the internal combustion engine 10 (also symbolized by a “-”). When the operator actuates the rotary switch of the second actuating means or element 80 (against the direction of arrow M), a position will be reached from a specific point in the actuating movement at which—when it is exceeded—the engine stop switch 70 will close the ignition circuit according to FIG. 5b (symbolized by a “+”) and the tank shut-off valve 60 releases the fuel supply (also symbolized by a “+”), so that the state as illustrated in FIG. 3 will be reached. The switching from the state as shown in FIG. 5b of “ready for operation” or “in operation” to the state of “engine off” as shown in FIG. 5a progresses in a respectively opposite way. The changeover occurs in a virtually simultaneous fashion, so that the operator switches the engine stop switch 70 and the tank shut-off valve 60 from the one to the other operating state in a joint and synchronous way via the second actuating means or element 80.

1. An actuating device for a soil compaction device comprising:
a first actuating element which is actuatable by hand and is configured for regulating engine power of the soil compaction device between an idle state and a full throttle state and
a second actuating device element which is actuatable by hand and is arranged for actuating a tank shut-off valve and an engine stop switch of the soil compaction device.

2. An actuating device according to claim 1, wherein the second actuating element is exclusively configured for actuating the tank shut-off valve and the engine stop switch.

3. An actuating device according to claim 1, wherein the second actuating element is arranged configured for the substantially simultaneous actuation of the tank shut-off valve and the engine stop switch during a switching process.

4. An actuating device according to claim 1, wherein the second actuating element is a rotary lever which comprises a grip end and a shaft which is connected in a torsion-proof manner with the grip end, wherein both the tank shut-off valve and also the engine stop switch can be actuated via the shaft.

5. An actuating device according to claim 4, wherein at least one co-rotating contact device for actuating the engine stop switch is arranged on the shaft.

6. An actuating device according to claim 5, wherein the contact device comprises a control surface.

7. An actuating device according to claim 6, wherein the control surface is arranged in a manner that it moves the engine stop switch orthogonally to a rotational axis (A) of the shaft.

8. An actuating device according to claim 4, wherein the shaft comprises a connecting device at its bottom axial end, which connecting device is arranged in a manner that it transmits a rotational movement of the rotary lever onto a rotary valve of the tank shut-off valve.

9. An actuating device according to claim 8, wherein rotational axes (A) of the rotary lever and the tank shut-off valve extend coaxially.

10. An actuating device according to claim 4, wherein the rotary lever is rotatably accommodated in a housing, and the rotational movement of the rotary lever is limited in the housing by at least one limit stop.

11. An actuating device according to claim 4, wherein a latching or locking device is provided for locking the rotary lever in at least one defined position.

12. An actuating device according to claim 4, wherein the rotary lever is made integrally of a plastic material.

13. An actuating device according to claim 1, wherein an elastic loading protection is provided, which is arranged in a manner that a maximum actuating path of the engine stop switch in at least one actuating direction is not exceeded.

14. A soil compaction device comprising an internal combustion engine and an actuating device according to claim 1.

15. A soil compaction device according to claim 14, wherein at least the second actuating element is fixed to a fuel tank of the soil compaction device.

16. An actuating device according to claim 1, wherein the soil compaction device comprises a vibration tamper.

17. An actuating device according to claim 6, wherein the control surface comprises a radially curved area.

18. A soil compaction device according to claim 14, wherein the soil compaction device comprises a tamper.

19. A soil compaction device according to claim 15, wherein the soil compaction device comprises a tamper.
